(19) United States
(12) Patent Application Publication
(10) Pub. No.: US 2006/0050027 A1
(43) Pub. Date: Mar. 9, 2006

(54) Image display unit and method for driving the same

(75) Inventors: Takeya Meguro, Tokyo (JP); Hisafumi Motoe, Saitama (JP); Yosuke Yamamoto, Chiba (JP); Hiroyuki Ikeda, Gifu (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Sony Corporation

(21) Appl. No.: 11/217,482

(22) Filed: Sep. 2, 2005

(30) Foreign Application Priority Data
Sep. 6, 2004 (JP) P2004-258162
Jun. 20, 2005 (JP) P2005-179912

(51) Int. Cl. G09G 3/22

(52) U.S. Cl. 345/75.2

(57) ABSTRACT

The image display unit includes a cathode electrode driving portion which applies a cathode electrode applied voltage to a cathode electrode, a gate electrode driving portion which sequentially applies a gate electrode applied voltage to a gate electrode according to an inputted shift clock for gate electrode selection, an abnormality detecting portion which detects at least either an input abnormality in the shift clock for gate electrode selection or an operation abnormality in a shift register, and a three-state buffer which controls the gate electrode applied voltage in the case where at least either of the abnormalities is detected, so that a potential difference between the cathode electrode and the gate electrode is equal to or lower than a cutoff voltage.

### CROSS REFERENCES TO RELATED APPLICATIONS

The present invention contains subject matter related to Japanese Patent Application JP 2004-258162 filed in the Japanese Patent Office on Sep. 6, 2004, and Japanese Patent Application JP 2005-179912 filed in the Japanese Patent Office on Jun. 20, 2005, the entire contents of which being incorporated herein by reference.

### BACKGROUND OF THE INVENTION

1. Field of the Invention

The present invention relates to an image display unit which displays an image through selecting and driving pixels arranged in a matrix form, and a method of driving the image display unit.

2. Description of the Related Art

In recent years, as one of flat display panels used for image display units, a field emission display (hereinafter referred to as FED) has been developed. As the FED has a principle that electrons emitted from an electron emission source in a vacuum hit a light emitting surface on which a light emitting layer is disposed so that light is emitted as in the case of a cathode ray tube (CRT), a flat panel display with high brightness and high contrast can be achieved. However, in the CRT, a single electron emission source is typically disposed in a position a dozen to a few tens of cm away from the light emitting surface. On the other hand, the FED has a different basic structure that a plurality of electron emission sources are arranged in a matrix form in positions approximately a few mm away from the light emitting surface.

Now, the basic structure and operations of a typical FED will be described in detail below. The FED includes a field emission type cathode as an electron emission source, a gate electrode facing the field emission type cathode, and an anode electrode which faces the gate electrode on a side opposite to the side where the field emission type cathode is disposed and is coated with a light emitting layer. The field emission type cathode includes a cathode device (a cold cathode device) having, for example, a conical shape, and a cathode electrode disposed on the bottom surface of the cathode device. When a gate-cathode voltage Vgc is applied between the cathode electrode and the gate electrode facing each other, electrons are emitted from the cathode device to hit the light emitting layer of the anode electrode. In general, the gate electrode is arranged in a row direction (Row), and the cathode electrode is arranged in a column direction (Column). A cathode device is disposed at each intersection of them to arrange a pixel in a matrix form. The cathode electrode is connected to a cathode electrode driving portion, and the gate electrode is connected to a gate electrode driving portion. The pixel arranged in a matrix form is driven by the above driving portions as below.

The drive of pixels is performed through applying a scanning voltage Vrow as a selection signal to a gate electrode in a target row from the gate electrode driving portion while applying a pixel voltage Vcol for one column to all cathode electrodes from a cathode electrode driving portion. When this operation is sequentially performed on all rows, one screenful of images is displayed. Thereby, a potential difference with reference to the cathode electrode (that is, a gate-cathode voltage Vgc (=Vrow−Vcol)) is generated between the gate electrode and the cathode electrode, and electrons are emitted from the cathode device by the potential difference. The emitted electrons pass through the gate electrode, and are attracted to the anode electrode to which a high voltage HV is applied to hit the anode electrode. At this time, by the energy of the electrons emitted by an impact, the light emitting layer emits light. Thereby, one screenful of images is displayed.

A technique about such a FED is disclosed in, for example, Japanese Unexamined Patent Application Publication No. 2001-324955.

### SUMMARY OF THE INVENTION

As described above, a typical FED has a matrix wiring structure for applying a voltage which drives pixels, and has a structure in which a pixel voltage is inputted from a cathode electrode driving portion, and a scanning voltage is sequentially inputted from a gate electrode driving portion. The scanning voltage is generally produced in the gate electrode driving portion, and then is outputted according to a scan clock inputted from a timing controller. Therefore, when the pixels are driven, in the case where the scan clock is not periodically inputted into the gate electrode driving portion, and the phase of the scan clock is shifted due to, for example, noises or the like, the light emission time of a scan line (a line extending in a row direction (in general, a horizontal direction on a screen)) is longer than normal, thereby the brightness of emitted light is higher than that in other scan lines. Therefore, a problem, that is, abnormal display that a high brightness line is generated in a horizontal direction on a screen occurs.

Moreover, in the case where the input of the scan clock into the gate electrode driving portion is suspended temporarily or for a long time due to an abnormality or the like in a CPU or a peripheral circuit, or, in the case where the gate electrode driving portion suffers damage, scanning for display may not be performed, and a voltage may be continuously applied only to a specific line. In this case, not only generating the high brightness line in a horizontal direction on the screen, the temperature of a part to which a voltage is continuously applied becomes higher than normal, thereby a decline in display characteristics in the cathode device due to deterioration or pixel damage such as damage to a resistive layer disposed on the bottom surface of the cathode device may occur.

In view of the foregoing, it is desirable to provide an image display unit capable of preventing abnormal display, a decline in display characteristics, and pixel damage due to an abnormal scan clock, damage to a gate electrode driving portion or the like, and a method of driving the image display unit.

According to an embodiment of the present invention, there is provided an image display unit including:

(A) a plurality of first electrodes and a plurality of second electrodes extending in a column direction and a row direction, respectively, so as to intersect and face each other in the position of each pixel;

(B) a first electrode driving means applying a pixel voltage to the first electrodes based on an image signal;

(C) a second electrode driving means sequentially applying a scanning voltage to the second electrodes according to an inputted scan clock, the scanning voltage selecting a pixel row to be driven;

(D) an abnormality detecting means detecting at least either an input abnormality in the scan clock or an operation abnormality in the second electrode driving means; and

(E) a scanning voltage control means controlling the scanning voltage applied to the second electrodes from the second electrode driving means in the case where at least either an input abnormality in the scan clock or an operation abnormality in the second electrode driving means is detected, so that a potential difference between the first electrodes and the second electrodes with reference to the first electrodes assumes equal to or lower than a predetermined value.

In this case, “a predetermined value” is preferably a cutoff voltage which is applied at the time of the lowest brightness display (so-called black display); however, the invention is not limited to this, and the predetermined value may be a little higher voltage than the cutoff voltage. Moreover, “an input abnormality in the scan clock” means that the scan clock is not inputted at right timing, and includes the case where the input of the scan clock is completely suspended, the case where the scan clock is temporarily suspended, and the case where the phase of the scan clock is shifted. Further, “an operation abnormality in the second electrode driving means” means that the second electrode driving means does not perform a predetermined normal operation, and includes, for example, the case where in spite of the fact that the scan clock is inputted, the application of a scanning voltage is not shifted from one of the second electrodes to the next second electrode.

The abnormality detecting means includes the following components as specific examples.

(1) In the case where an input abnormality in the scan clock is detected, the abnormality detecting means includes: a capacitor; a charging circuit charging the capacitor; a discharging circuit discharging the capacitor according to an input of the scan clock; and a comparison circuit comparing the charging voltage of the capacitor to a reference voltage to detect an input abnormality in the scan clock when the charging voltage exceeds the reference voltage.

In this case, “comparing” means comparing the level of the charging voltage of the capacitor to the level of the reference voltage.

(2) In the case where an operation abnormality in the second electrode driving means is detected, more specifically in the case where the operation abnormality in a shift register which is one of components of the second electrode driving means is detected, the abnormality detecting means includes a comparison circuit comparing the vertical synchronous signal to a final stage output of the shift register, and detecting an operation abnormality in the second electrode driving means when the result of a comparison shows mismatch between the vertical synchronous signal and the final stage output of the shift register.

In this case, the above-described shift register has a function of sequentially shifting the inputted vertical synchronous signal according to the scan clock. Moreover, “comparing” in this case means comparing the level of the vertical synchronous signal to the level of a final stage output of the shift register.

In order for the scanning voltage control means to make the potential difference equal to or lower than the predetermined value, the following techniques can be considered as specific examples.

(1) Turn off the output of the scanning voltage in the second electrode driving means.

In this case, “turn off” means shutting down the output of the scanning voltage to the second electrode while the second electrode driving means operates.

(2) Turn off the output of a power source which supplies power to the second electrode driving means.

(3) Reduce the output of a power source which supplies power to the second electrode driving means.

According to an embodiment of the invention, there is provided a method of driving an image display unit including the following steps of:

(A) arranging a plurality of first electrodes and a plurality of second electrodes extending in a column direction and a row direction, respectively, so as to intersect and face each other in the position of each pixel;

(B) applying a pixel voltage to the first electrodes based on an image signal;

(C) sequentially applying a scanning voltage to the second electrodes according to an inputted scan clock, the scanning voltage selecting a pixel row to be driven;

(D) detecting at least either an input abnormality in the scan clock or an operation abnormality in the second electrode driving means; and

(E) reducing the scanning voltage in the case where at least either an input abnormality in the scan clock or an operation abnormality in the second electrode driving means is detected, so that a potential difference between the first electrodes and the second electrodes with reference to the first electrodes assumes equal to or lower than a predetermined value.

In the image display unit and the method of driving an image display unit according to the embodiment of the invention, when at least either an input -abnormality in the scan clock or an operation abnormality in the second electrode driving means is detected, the scanning voltage which is applied to the second electrodes from the second electrode driving means is controlled so that the potential difference assumes equal to or lower than the predetermined value. Thereby, a voltage exceeding the predetermined value can be prevented from being continuously applied to a pixel selected by the second electrode driving means when the above-described abnormality occurs.

In the image display unit and the method of driving an image display unit according to the embodiment of the invention, when the input abnormality occurs in the scan clock or the operation abnormality occurs in the second electrode driving means, the scanning voltage which is applied to the second electrodes from the second electrode driving means is reduced, so that the potential difference assumes equal to or lower than the predetermined value, so abnormal display, a decline in display characteristics, and pixel damage due to an abnormal input of the shift clock for gate electrode selection can be prevented.

Other and further objects, features and advantages of the invention will appear more fully-from the following description.

### BRIEF DESCRIPTION OF THE DRAWINGS

FIG. 1 is a schematic block diagram of an image display unit according to a first embodiment of the invention;

FIG. 2 is a sectional view of an image display device taken along a plane perpendicular to an X axis and a Y axis;

FIG. 3 is a perspective view of the image display device;

FIG. 4 is a schematic block diagram of a gate electrode driving portion and an abnormality detecting portion;

FIG. 5 is a schematic block diagram of a power source;

FIG. 6 is a plot of an electron emission characteristic of the image display unit;

FIGS. 7A through 7G are waveform diagrams of main signals of the device driving portion;

FIGS. 8A and 8B are waveform diagrams of a cathode electrode applied voltage in an X-axis direction;

FIGS. 9A through 9E are waveform diagrams for describing the operation of the abnormality detecting portion under a normal condition;

FIGS. 10A through 10C are waveform diagrams for describing a comparative example;

FIGS. 11A through 11E are waveform diagrams for describing the operation of the abnormality detecting portion under an abnormal condition;

FIG. 12 is a flowchart for describing the steps of detecting an abnormality;

FIG. 13 is a schematic block diagram of a gate electrode driving portion and an abnormality detecting portion according to a second embodiment of the invention;

FIGS. 14A through 14F are waveform diagrams for describing the operation of the abnormality detecting portion under an abnormal condition;

FIG. 15 is a schematic block diagram of a gate electrode driving portion and an abnormality detecting portion according to a third embodiment of the invention;

FIGS. 16A through 16E are waveform diagrams for describing the operation of the abnormality detecting portion under a normal condition;

FIGS. 17A through 17C are waveform diagrams for describing a comparative example;

FIGS. 18A through 18E are waveform diagrams for describing the operation of the abnormality detecting portion under an abnormal condition;

FIG. 19 is a flowchart for describing the steps of detecting an abnormality;

FIG. 20 is a schematic block diagram of a gate electrode driving portion and an abnormality detecting portion according to a modification of the second embodiment; and

FIG. 21 is a schematic block diagram of a power source shown in FIG. 20.

### DETAILED DESCRIPTION OF THE PREFERRED EMBODIMENTS

Preferred embodiments will be described in detail below referring to the accompanying drawings.

### First Embodiment

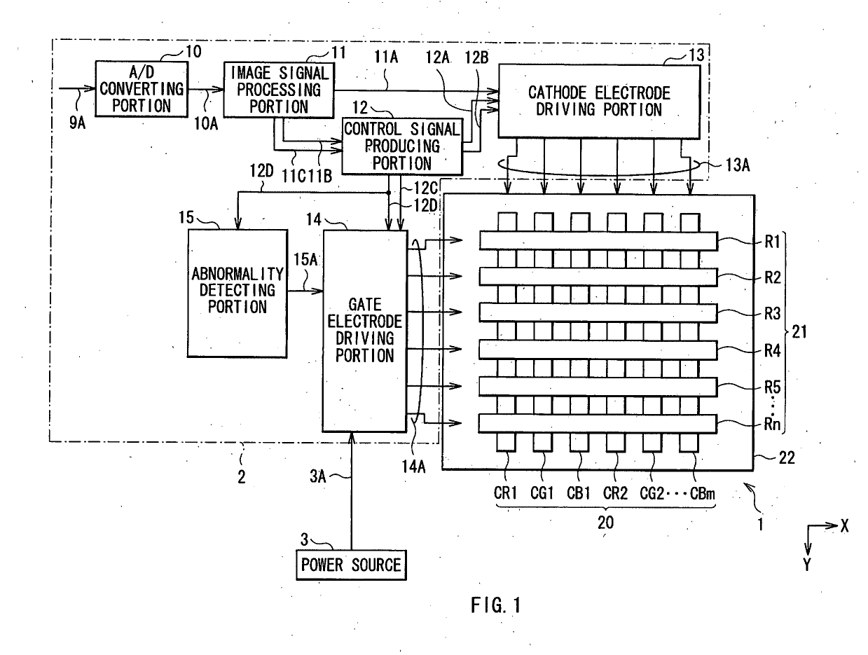

FIG. 1 shows a schematic block diagram of an image display unit according to a first embodiment of the invention. A method of driving an image display unit according to the embodiment is exemplified by the image display unit according to the embodiment, so the method will be also described below.

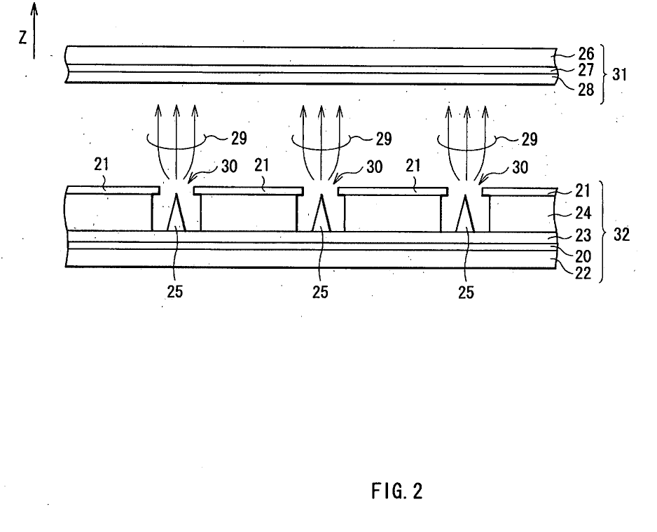

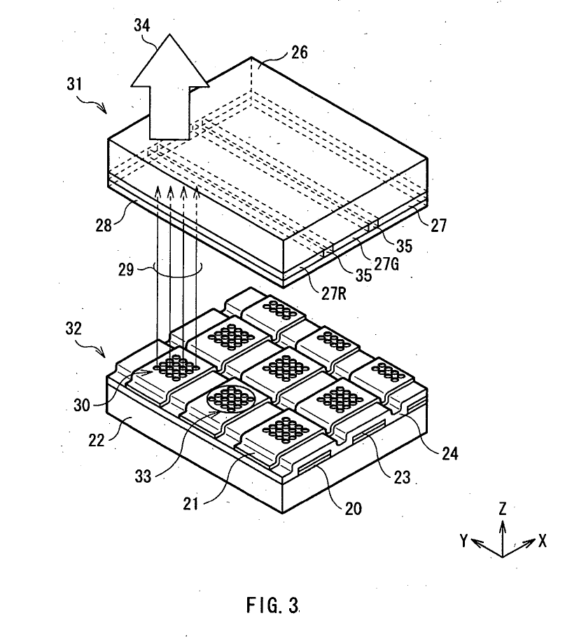

The image display unit includes an image display device 1 for displaying an image, a device driving portion 2 for driving the image display device 1 and a power source 3 for supplying power to the device driving portion 2. FIG. 2 shows a sectional view of the image display device 1 taken along a plane perpendicular to a row direction (an X axis) and a, column direction (a Y axis). Moreover, FIG. 3 shows a partially enlarged perspective view of the image display device 1. In the embodiment, the case where a passive matrix is used as a driving system will be described as an example. In the following description, “top” indicates a positive direction of a direction (a Z axis) perpendicular to a row direction (an X axis) and a column direction (a Y axis), and “bottom” indicates a negative direction of the Z axis.

The image display device 1 includes a plurality of cathode electrodes 20 (first electrodes) extending in a Y-axis direction on a supporting body 22 having a plane perpendicular to the Z axis. A resistive layer 23 is formed on each of the cathode electrodes 20, (refer to FIGS. 2 and 3). The supporting body 22, the cathode electrodes 20 and the resistive layers 23 are covered with an insulating layer 24. The image display device 1 includes a plurality of gate electrodes 21 extending in an X-axis direction on the insulating layer 24. In this case, m columns of cathode electrodes 20, are arranged, and n rows of gate electrodes 21 are arranged. Herein, m and n are positive integers. When viewed from a Z-axis direction, a position where each cathode electrode 20 and each gate electrode 21 intersect each other is an electron emission region 33, and each pixel is formed in the electron emission region 33. In the gate electrode 21 and the insulating layer 24 in the electron emission region 33, a plurality of holes 30 penetrating the gate electrode 21 and the insulating layer 24 are formed, and cathode devices 25 are disposed on the resistive layer 23 disposed on bottom portions of the holes 30. The cathode electrode 20 and the cathode devices 25 are electrically connected to each other through the resistive layer 23 in between. The supporting body 22 and all components formed on the supporting body 22 are collectively called a cathode panel 32 (refer to FIGS. 2 and 3).

The image display device 1 also includes an anode substrate 26 facing the cathode panel 32 above the gate electrodes 21, and further includes an anode electrode 28 (a second electrode) on the bottom side of the anode substrate 26. On the bottom side of the anode electrode 28, a plurality of strap-shaped light emitting layers 27 are arranged corresponding to positions facing the electron emission regions 33. A black matrix 35 is formed between the strap-shaped light emitting layers 27 adjacent to each other. Each of the light emitting layers 27 includes a light emitting layer for R (red) 27R, and a light emitting layer for G (green) 27G and a light emitting layer for B (blue) 27B which are made of a phosphor which emits fluorescence of a corresponding color. The light emitting layers 27R, 27G and 27B extend in a Y-axis direction, and they are repeatedly arranged in an X-axis direction in the order of 27R, 27G and 27B. The anode substrate 26 and all components formed on the bottom side of the anode substrate 26 are collectively called an anode panel 31. The cathode panel 32 and the anode panel 31 face each other with a predetermined spacing in between, and a near vacuum is maintained in the spacing.

As described above, the image display device 1 uses the light emitting layers 27R, 27G and 27B as the light emitting layer 27, so a color image can be displayed; however, in the embodiment, in order to simplify the description, the embodiment will be described without distinction between colors in color display.

As shown in FIG. 1, the device driving portion 2 includes an A/D converting portion 10, an image signal processing portion 11, a control signal producing portion 12, a cathode electrode driving portion 13 (a first electrode driver), a gate electrode driving portion 14 (a second electrode driver and a scanning voltage controller) and an abnormality detecting portion 15 (an abnormality detector). A power source 3 supplies a necessary voltage to these components.

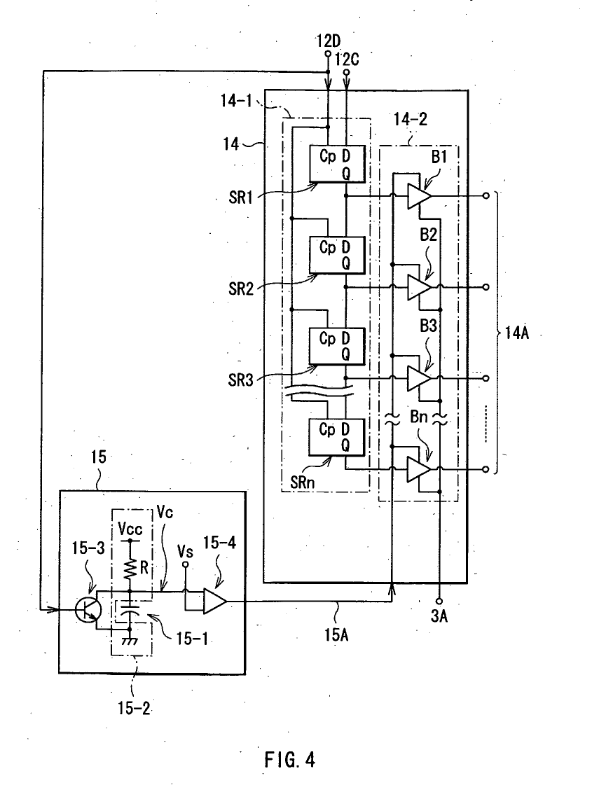

FIG. 4 shows specific structures of the gate electrode driving portion 14 and the abnormality detecting portion 15. The gate electrode driving portion 14 includes a shift register 14-1 and a three-state buffer 14-2. The abnormality detecting portion 15 includes a capacitor 15-1, a charging circuit 15-2, a discharging circuit 15-3 and a comparison circuit 15-4.

Next, referring to FIGS. 1 and 4, the connection relationship between all components of the device driving portion 2 will be described below.

The output of the A/D converting portion 10 is connected to the input of the image signal processing portion 11. The output of the image signal processing portion 11 is connected to the inputs of the control signal producing portion 12 and the cathode electrode driving portion 13. The output of the control signal producing portion 12 is connected to the inputs of the cathode electrode driving portion 13, the gate electrode driving portion 14 and the abnormality detecting portion 15. The output of the abnormality detecting portion 15 is connected to the input of the gate electrode driving portion 14. The outputs of the cathode electrode driving portion 13 and the gate electrode driving portion 14 are connected to the input of the image display device 1.

In the gate electrode driving portion 14, the input of the shift register 14-1 is connected to the output of the control signal producing portion 12. The input of the three-state buffer 14-2 is connected to the outputs of the shift register 14-1 and the abnormality detecting portion 15, and the output of the three-state buffer 14-2 is connected to the gate electrodes 21. The three-state buffer 14-2 is also connected to the power source 3.

In the abnormality detecting portion 15, the charging circuit 15-2 is connected to the capacitor 15-1 in series. The output of the discharging circuit 15-3 is connected to the capacitor 15-1 in parallel, and the input of the discharging circuit 15-3 is connected to the output of the control signal producing portion 12. The input of the comparison circuit 15-4 is connected to the high potential side of the capacitor 15-1, and the output of the comparison circuit 15-4 is connected to the input of the three-state buffer 14-2.

Next, referring to FIGS. 1 and 4, functions of the components of the device driving portion 2 will be described below.

The A/D converting portion 10 converts an analog image signal 9A from an image signal source (not shown) into a digital image signal 10A, and supplies the digital image signal 10A to the image signal processing portion 11. The digital image signal 10A includes a horizontal synchronous signal 11B and a vertical synchronous signal 11C. In the case where an image signal supplied from the image signal source is a digital signal, the A/D converting portion 10 is not necessary.

The image signal processing portion 11 extracts an image signal 11A for the jth row from the digital image signal 10A to input the image signal 11A for the jth row into the cathode electrode driving portion 13, and extracts the horizontal synchronous signal 11B and the vertical synchronous signal 11C from the digital image singal 10A to input them into the control signal producing portion 12. In this case, j is a value within a range from 1 to n (n is the total number of the gate electrodes 21).

The control signal producing portion 12 generates an image signal capture start pulse 12A and a cathode electrode drive start pulse 12B according to the horizontal synchronous signal 11B and the vertical synchronous signal 11C to input them into the cathode electrode driving portion 13. Moreover, the control signal producing portion 12 generates a gate electrode drive start pulse 12C and a shift clock for gate electrode selection 12D (a scan clock) according to the horizontal synchronous signal 11B and the vertical synchronous signal 11C so as to input them into the gate electrode driving portion 14. The control signal producing portion 12 also inputs the shift clock for gate electrode selection 12D into the abnormality detecting portion 15.

The cathode electrode driving portion 13 generates a cathode electrode applied voltage 13A (a pixel voltage) through modulating the image signal 11A for the jth row to input the cathode electrode applied voltage 13A to the image display device 1.

The gate electrode driving portion 14 sequentially selects one register SRj in the shift register 14-1 in synchronization with the gate electrode drive start pulse 12C inputted into the shift register 14-1 and the shift clock for gate electrode selection 12D, and sequentially selects one buffer Bj in the three-state buffer 14-2 connected to an output Q of the register SRj. Moreover, a gate electrode applied voltage 14A (a scanning voltage) is inputted from the selected buffer Bj to the gate electrode 21. The gate voltage 3A as the output of the power source 3 is inputted into the three-state buffer 14-2, thereby the gate electrode applied voltage 14A (a scanning voltage) is inputted from the selected buffer Bj to the gate electrode 21.

The abnormality detecting portion 15 discharges a charge which is charged in the capacitor 15-1 by the charging circuit 15-2 in synchronization with the shift clock for gate electrode selection 12D inputted into the discharging circuit 15-3. Moreover, the comparison circuit 15-4 compares the level of a voltage Vc generated by charge to the level of a reference voltage Vs. In the case where the charging voltage Vc is equal to or lower than the reference voltage Vs, an output enable signal 15A which means enabling to output the gate electrode applied voltage 14A is inputted from the comparison circuit 15-4 to the three-state buffer 14-2. On the other hand, in the case where the charging voltage Vc is higher than the reference voltage Vs, the output of output enable signal 15A is suspended.

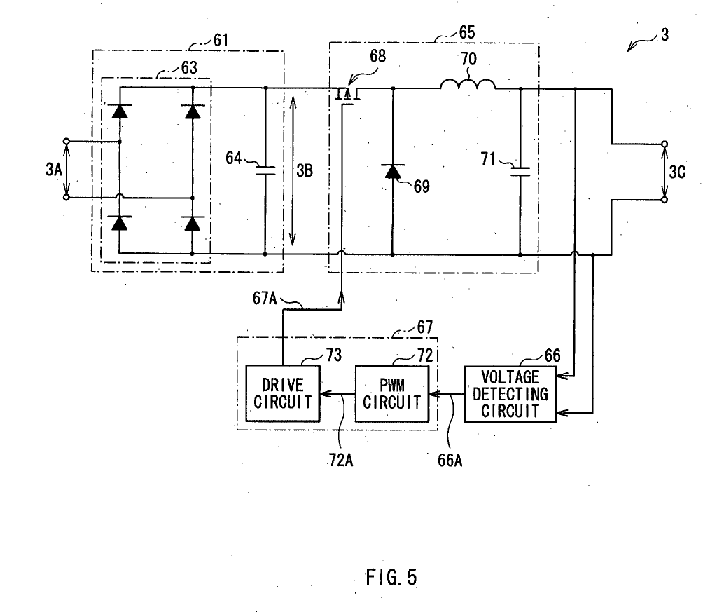

FIG. 5 shows a part of a detailed structure of the power source 3. The power source 3 is an AC-DC converter in which a chopper circuit 62 is connected to a rectifier smoothing circuit 61 in series, and the power source 3 supplies power to other components. FIG. 5 shows a specific example of a detailed structure of a component of the power source 3 which is necessary to supply power to the three-state buffer 14-2. The detailed structure shown in FIG. 5 will be described below.

The rectifier smoothing circuit 61 includes a rectifier circuit 63 to which a rectifier diode is bridged and a smoothing capacitor 64 which are connected to each other in series, and the rectifier smoothing circuit 61 converts an AC voltage 3A from outside into a DC voltage 3B. The chopper circuit 62 includes a power converting circuit 65, a voltage detecting circuit 66 and a voltage regulator circuit 67. The voltage converting circuit 65 includes a MOSFET 68, a diode 69, a reactor 70 and a capacitor 71, and the voltage converting circuit 65 reduces the DC voltage 3B to a DC voltage (a gate voltage 3C) within a drive voltage range of the three-state buffer 14-2. The voltage detecting circuit 66 includes, for example, a voltage-dividing resistor and a comparator, and outputs a signal 66A according to the value of a difference between the gate voltage 3C and the reference voltage to the voltage regulator circuit 67. The voltage regulator circuit 67 includes a PWM circuit 72 and a drive circuit 73, and in the PWM circuit 72, the pulse width of a pulse signal 72A outputted to the drive circuit 73 is determined according to the inputted signal 66A, and in the drive circuit 73, the amplitude of a pulse signal 67A inputted into the gate of the MOSFET 68 is determined according to the pulse signal 72A.

Next, the operation of the image display unit with the above-described structure will be described below.

At first, referring to FIGS. 2 and 3, the principle of light emission will be described below.

The cathode electrode applied voltage 13A (=Vcol (Ci, Rj)) is applied to the cathode electrode 20, and the gate electrode applied voltage 14A (=Vrow (Rj)) is applied to the gate electrode 21. Thereby, a gate-cathode voltage (Vgc (Ci, Rj)=Vcol (Ci, Rj)−Vrow (Rr)) with reference to the cathode electrode 20 is applied between the gate electrode 21 (=Rj) in the jth row and the cathode electrode 20. Therefore, by an electric field generated by this, electrons 29 are emitted from the cathode device 25 (refer to FIG. 2). At this time, when a voltage HV (>Vrow (Rj)) is applied to the anode electrode 28, the electrons 29 are attracted to the anode electrode 27 to hit the anode electrode 27. Thereby, an anode current Ia flows in a direction from the anode electrode 28 to the cathode electrode 22. At this time, the anode electrode 28 is coated with the light emitting layer 27, so the light emitting layer 27 emits light by the energy of the impact of electrons. In the following description, the gate-cathode voltage Vgc (Ci, Rj) indicates “gate-cathode voltage Vgc” or simply “voltage Vgc”.

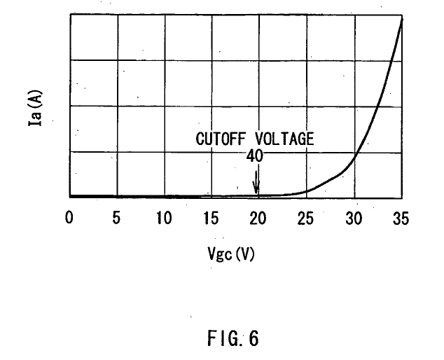

Next, referring to FIG. 6, grayscale display will be described below.

FIG. 6 shows a relationship between the gate-cathode voltage Vgc and the anode current Ia (an electron emission characteristic). It is obvious from the plot that in the electron emission characteristic, when the gate-cathode voltage Vgc is equal to or lower than a cutoff voltage 40 (for example, 20V), electrons contributing to light emission are hardly emitted, and on the other hand, when the voltage Vgc is higher than the cutoff voltage 40, the electrons contributing to light emission are emitted. Therefore, through the use of the characteristic, grayscale display is performed.

For example, it is assumed that the gate electrode driving portion 14 selects a gate electrode in the jth row (for example, the voltage is set to 35 V). At this time, the cathode electrode applied voltage 13A is set to the highest brightness level (that is, so-called white level; for example, 0 V), the gate-cathode voltage Vgc is 35 V. It is obvious from FIG. 6 that as the amount of electrons (the current Ia) emitted from the cathode device 25 at this time is large, light emitted from the light emitting layer 27 has high brightness.

On the other hand, in the case where the cathode electrode applied voltage 13A is set to the lowest brightness level (that is, a so-called black level; for example, 15 V), the gate-cathode voltage Vgc is 20 V. The cathode electrode applied voltage Vgc at this time is close to the cutoff voltage 40, and the amount of electrons (the current Ia) emitted from the cathode device 25 is extremely small, so the light emission from the light emitting layer 27 hardly occurs, so the brightness of light is low.

Thereby, when the cathode electrode applied voltage 13A is limited within a range from 0 V to 15 V according to the value of the digital image signal 10A, various brightness levels can be displayed, and desired grayscale display can be performed.

Next, the operation of the device driving portion 2 will be described below.

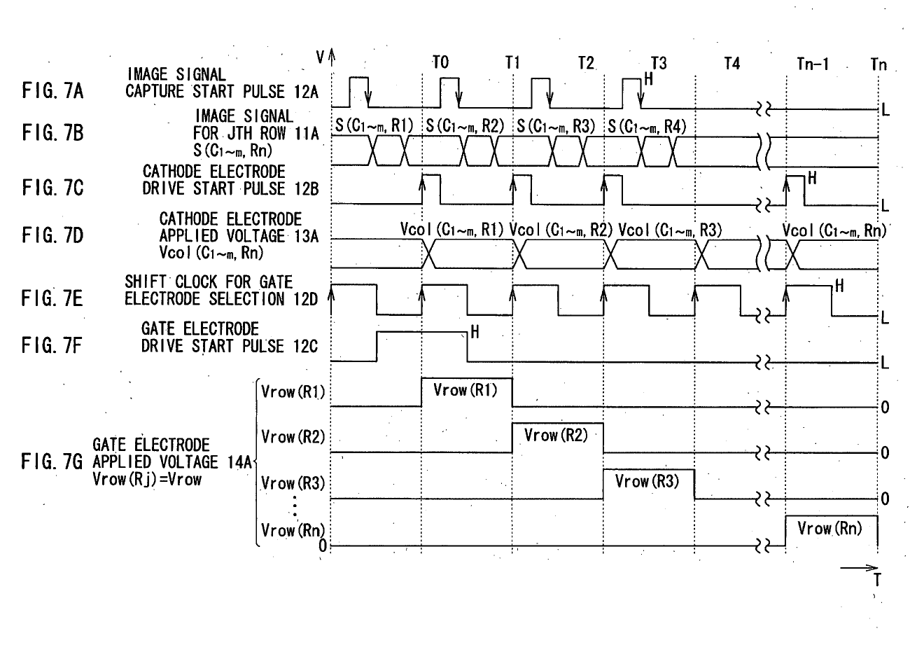

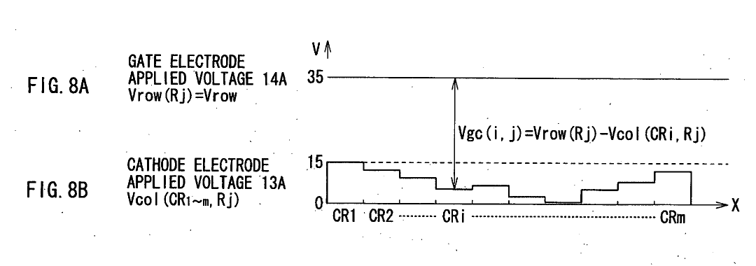

FIGS. 7A through 7G show the timing of main signals in the device driving portion 2. The horizontal axis indicates time, and the vertical axis indicates voltage. FIGS. 8A and 8B show an example of the relationship between the cathode electrode applied voltage 13A for the jth row and the gate electrode applied voltage 14A. The horizontal axis indicates the number of cathode electrodes arranged in an X direction, and the vertical axis indicates voltage. In FIGS. 8A and 8B, in order to simplify the description, only a cathode electrode for R (red) CRi (i=1 to m) is shown.

At first, the A/D converting portion 10 converts the analog image signal 9A into the digital image signal 10A. At this time, the digital image signal 10A includes, for example, 8-bit digital image signals for R (red), G (green) and B (blue), the horizontal synchronous signal 11B and, the vertical synchronous signal 11C. The A/D-converting portion 10 inputs the digital image signal 10A into the image signal processing portion 11.

The image signal processing portion 11 performs various signal processing such as image quality adjustment on the inputted digital image signal 10A, and extracts the horizontal synchronous signal 11B and the vertical synchronous signal 11C from the digital image signal 10A to input them into the control signal producing portion 12. The image signal processing portion 11 also inputs the image signal 11A (refer to FIG. 7B) for one row (in this case, the jth row) into the cathode electrode driving portion 13 in synchronization with a reference clock (not shown). The cathode electrode driving portion 13 captures the image signal 11A, and temporarily stores the image signal 11A.

The control signal producing portion 12 inputs the image signal capture start pulse 12A (refer to FIG. 7A) which indicates the image capture start timing in the cathode electrode driving portion 13 into the cathode electrode driving portion 13 according to the horizontal synchronous signal 11B and the vertical synchronous signal 11C. The control signal producing portion 12 inputs the cathode electrode drive start pulse 12B (refer to FIG. 7C) for instructing to output the image signal 11A for the jth row, which is temporarily stored in the cathode electrode driving portion 13, to the image display device 1, into the cathode electrode driving portion 13 according to the horizontal synchronous signal 11B and the vertical synchronous signal 11C.

The cathode electrode driving portion 13 virtually concurrently outputs the cathode electrode applied voltage 13A (refer to FIG. 7D) as a modulation signal corresponding to the image signal for the jth row to each cathode electrode 20 in the image display device 1 in synchronization with the cathode electrode drive start pulse 12B. Thereby, the cathode electrode applied voltage 13A (=Vcol (Ci, Rj), (i=1 to m)) exemplified in FIG. 8B is outputted to the cathode electrode 20.

The control signal producing portion 12 inputs the gate electrode drive start pulse 12C and the shift clock for gate electrode selection 12D into the gate electrode driving portion 14 according to the horizontal synchronous signal 11B and the vertical synchronous signal 11C (refer to FIGS. 7E and 7F). When the shift clock for gate electrode selection 12D is inputted from the control signal generating portion 12 in the case where the gate electrode drive start pulse 12C is inputted from the control signal generating portion 12, the gate electrode driving portion 14 outputs the gate electrode applied voltage 14A (=Vrow (R1)) to the gate electrode 21 in the first row in synchronization with the shift clock for gate electrode selection 12D (refer to FIG. 7G). On the other hand, when the shift clock for gate electrode selection 12D is inputted from the control signal generating portion 12 in the case where the gate electrode drive start pulse 12C is not inputted from the control signal generating portion 12, the gate electrode applied voltage 14A (=Vrow (Rj), 2≦j≦n) is outputted to the gate electrode 21 in the jth row in synchronization with the shift clock for gate electrode selection 12D (refer to FIG. 7G).

The above steps are repeated for the number n of the gate electrodes 21. Thereby, a process for displaying one screenful of images is completed. In addition, one screenful of images may be displayed through synchronizing each signal through the use of any method other than the above-described method.

When the above-described process for displaying one screenful of images is repeated, a plurality of screenfuls of images can be continuously displayed in the image display unit.

Next, the operation of the abnormality detecting portion 15 will be described in detail below.

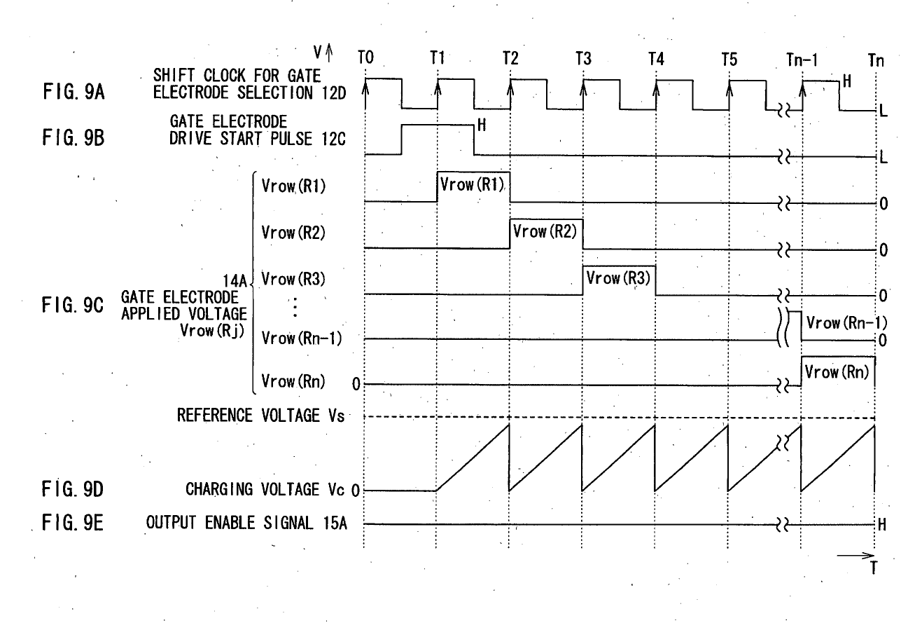

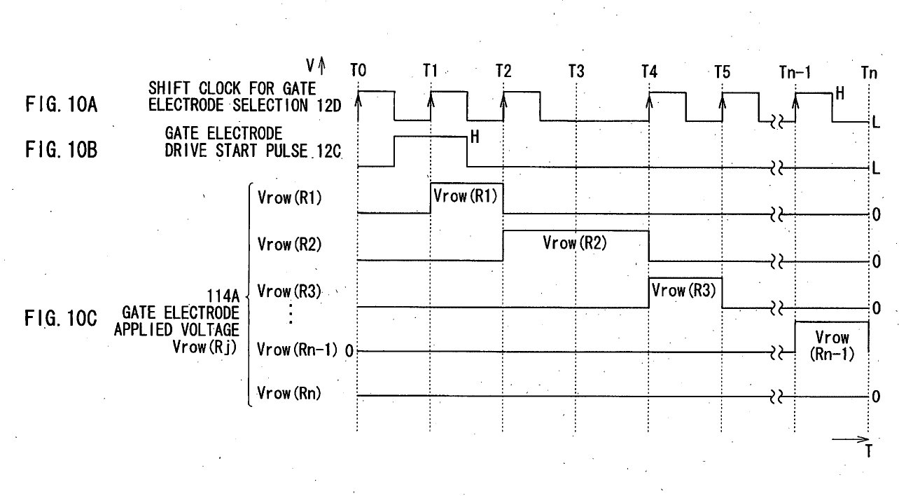

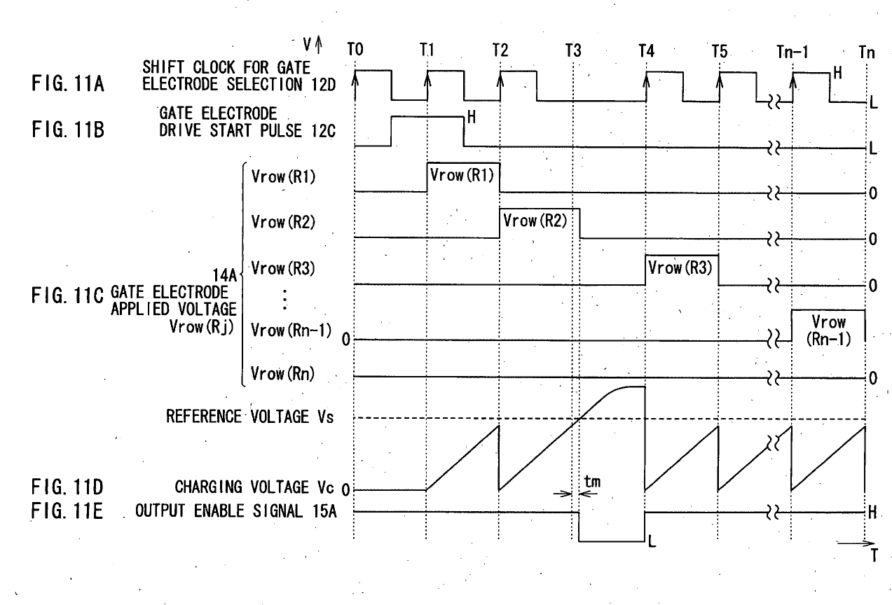

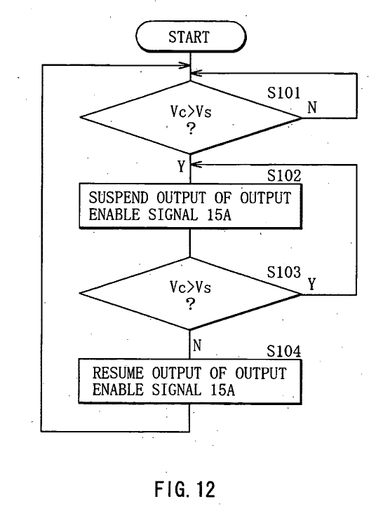

FIGS. 9A through 9E shows timing charts for describing the operation of the abnormality detecting portion 15 in the case where the shift clock for gate electrode selection 12D is normal in the embodiment. FIGS. 10A through 10C show timing charts for describing the state in which the shift clock for gate electrode selection 12D is abnormal in the case where the abnormality detecting portion 15 is not included as a comparative example. More specifically, FIGS. 10A through 10C show the case where the shift clock for gate electrode selection 12D lags the normal shift clock for gate electrode selection 12D by one period due to noises or the like. FIGS. 11A through 11E show timing charts for describing the operation of the abnormality detecting portion 15 in the case where an abnormality occurs in the shift clock for gate electrode selection 12D as shown in FIGS. 10A through 10C in the embodiment. FIG. 12 shows the steps of detecting an abnormality by the abnormality detecting portion 15.

The abnormality detecting portion 15 regularly monitors the shift clock for gate electrode selection 12D outputted from the control signal producing portion 12, while the device driving portion 2 operates. As shown in FIG. 9A, the shift clock for gate electrode selection 12D has a pulse waveform, and generally has a fixed period. The period is determined to optimally adjust the brightness of an image, and is determined in consideration of characteristics such as brightness saturation. Thus, in general, the pulse waveform is periodically inputted into the discharging circuit 15-3. The discharging circuit 15-3 discharges the charging voltage Vc before exceeding the reference voltage Vs as shown in FIG. 9D by the periodic pulse waveform inputted from the control signal producing portion 12. The comparison circuit 15-4 keeps outputting the output enable signal 15A to the three-state buffer 14-2 in the case where the charging voltage Vc does not exceed the reference voltage Vs. In other words, the abnormality detecting portion 15 enables to output to the three-state buffer 14-2 in the case where the shift clock for gate electrode selection 12D is normal, more specifically in the case where the charging voltage Vc does not exceed the reference voltage Vs (step S101).

Now, the state in which the abnormality detecting portion 15 is not included in the device driving portion 2 in the case where an abnormality occurs in the shift clock for gate electrode selection 12D is considered as a comparative example. For example, as shown in FIG. 10A, the case where the phase of the shift clock for gate electrode selection 12D lags the normal shift clock for gate electrode selection 12D by one period will be considered below. When the phase lags one period, as shown in FIG. 10C, the gate electrode applied voltage Vrow (R2) is applied to a gate electrode (R2) in the second row for twice as long as a normal time. In other words, the gate-cathode voltage Vgc exceeding the cutoff voltage 40 is applied to a pixel (Ci, R2) corresponding to the gate electrode (R2) in the second row for twice as long as the normal time.

As a result, the light emission brightness of the pixel (Ci, R2) is higher than other lines, thereby a high brightness line in a horizontal direction is generated on a screen. Moreover, in addition to the above-described abnormality, for example, in the case where the shift clock for gate electrode selection 12D inputted into the gate electrode driving portion 14 disappears due to an abnormality or the like in a CPU or a peripheral circuit, the voltage Vrow (Rj) is applied as a scanning signal for a longer time than that in the case where the phase lags as described above. Therefore, when such an abnormality occurs, in addition to the generation of the high brightness line in a horizontal direction on the screen, a decline in characteristics in the cathode device due to deterioration may occur, or damage to a resistive layer disposed on the bottom surface of the cathode device may occur.

However, in the case where the abnormality detecting portion 15 is included in the device driving portion 2 as in the embodiment, the above problems can be solved. More specifically, as described above, in the case where the shift clock for gate electrode selection 12D disappears due to an abnormality or the like in the CPU or the peripheral circuit, or in the case where the phase of the shift clock for gate electrode selection 12D lags the normal shift clock for gate electrode selection 12D due to noises or the like, the pulse waveform of the shift clock for gate electrode selection 12D is not inputted into the discharging circuit 15-3 or is inputted into the discharging circuit 15-3 behind the normal shift clock for gate electrode selection 12D. As shown in FIG. 11D, before the pulse waveform of the shift clock for gate electrode selection 12 is inputted into the discharging circuit 15-3, the charging voltage Vc exceeds the reference voltage Vs. When the comparison circuit 15-4 detects that the charging voltage Vc exceeds the reference voltage Vs, as shown in FIG. 11E, the output of the output enable signal 15A is suspended immediately. Moreover, the comparison circuit 15-4 keeps suspending the output of the output enable signal 15A until the comparison circuit 15-4 detects that the charging voltage Vc falls below the reference voltage Vs (step S102). Thus, in the case where an abnormality occurs in the shift clock for gate electrode selection 12D, as shown in FIG. 11C, the abnormality detecting portion 15 suspends the output from the three-state buffer 14-2 to the gate electrode 21. In order to prevent from suspending the output of the output enable signal 15A even in the case where the shift clock for gate electrode selection 12D is normal, as shown in FIG. 11D, a predetermined margin tm is provided.

Now, the description will be given referring to FIG. 6. As described above, the gate electrode applied voltage 14A declines, for example, from 35 V to 0 V through suspending the output from the three-state buffer 14-2 to the gate electrode 21. At this time, the cathode electrode applied voltage 13A is 0 V to 15 V based on an image signal. Therefore, the gate-cathode voltage Vgc with reference to the cathode electrode 20 is 0 V to 15 V, so the voltage Vgc does not exceed the cutoff voltage 40 (for example, 20 V), and electrons 29 are not emitted from the cathode device 25 so that the light emitting layer 27 does not emit light. Moreover, the absolute value of the gate-cathode voltage Vgc does not exceed the cutoff voltage 40.

Thereby, in the case where an abnormality occurs in the shift clock for gate electrode selection 12D, the gate-cathode voltage Vgc exceeding the cutoff voltage 40 can be prevented from being applied to pixels for a time largely exceeding the normal time.

Therefore, in the embodiment, there is no possibility that abnormal display that the high brightness line in a horizontal direction is generated on the screen occurs, and there is no possibility that a decline in display characteristics in the cathode device due to deterioration or the like, or pixel damage such as damage to the resistive layer disposed on the bottom surface of the cathode device occurs.

Thus, in the embodiment, in the case where an abnormality occurs in the shift clock for gate electrode selection 12D, the output from the gate electrode driving portion 14 to the gate electrode 21 is suspended, so that the gate-cathode voltage Vgc assumes equal to or lower than the cutoff voltage 40, so abnormal display, a decline in display characteristics, and pixel damage due to an abnormal input of the shift clock for gate electrode selection 12D can be prevented.

In the case where the pulse waveform of the shift clock for gate electrode selection 12D is inputted into the discharging circuit 15-3 after the output to the gate electrode driving portion 14 is suspended, the charging voltage Vc is discharged as described above, so the charging voltage Vc falls below the reference voltage Vs. In the case where the comparison circuit 15-4 detects that the charging voltage Vc falls below the reference voltage Vs (step S103), as shown in FIG. 11E, the output of the output enable signal 15A is resumed (step S104). As a result, the suspension of the output to the gate electrode driving portion 14 is removed. Therefore, in the embodiment, in the case where the shift clock for gate electrode selection 12D is recovered to a normal condition, more specifically in the case where the shift clock for gate electrode selection 12D is inputted into the abnormality detecting portion 15 again, the gate electrode driving portion 14 can continue scanning the gate electrode.

### Second Embodiment

Next, a second embodiment of the invention will be described below.

In the first embodiment, in the case where an abnormality occurs in the shift clock for gate electrode selection 12D, the output of the gate electrode applied voltage 14A is suspended through suspending the output of the output enable signal 15A which means enabling to output the gate electrode applied voltage 14A. On the other hand, in the embodiment, in the case where the above-described abnormality occurs, the output of a gate electrode applied voltage 44A is suspended through suspending the output of an input enable signal 15C which means enabling to input an input voltage (a gate voltage 3A) from the power source 3.

In other words, the embodiment differs in including a switch, which can turn on or off the input voltage (the gate voltage 3A) from the power source 3 according to the input enable signal 15C inputted from the abnormality detecting portion 15, between the power source 3 and the three-state buffer 14-2. The same structures, operations and functions as those in the first embodiment will not be further described, and the above-described difference will be described in detail below.

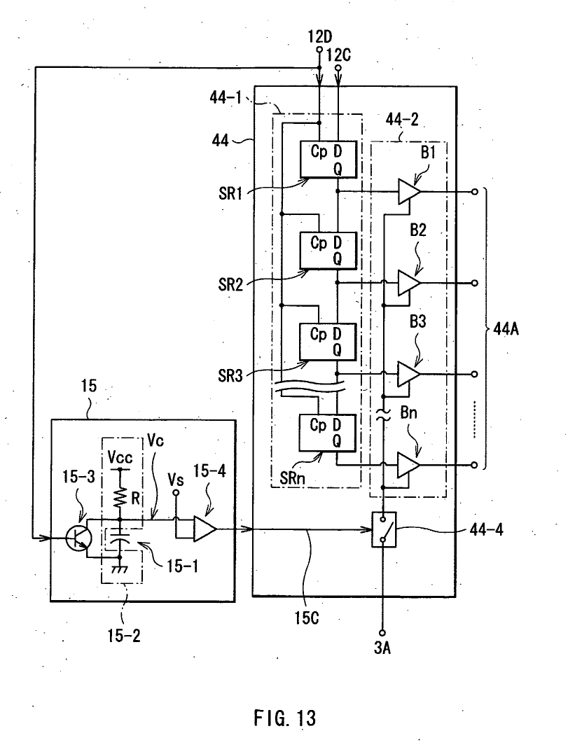

FIG. 13 shows a schematic block diagram of a gate electrode driving portion 44 (a second electrode driver and a scanning voltage controller) and the abnormality detecting portion 15 according to the embodiment. The gate electrode driving portion 44 includes a shift register 44-1, a three-state buffer 44-2 and a switch 44-4.

The input of the shift register 44-1 is connected to the output of the control signal producing portion 12. The input of the three-state buffer 44-2 is connected to the output of the shift register 44-1 and the output of the switch 44-4. The output of the three-state buffer 44-2 is connected to the gate electrode 21. The input of the switch 44-4 is connected to the output of the power source 3 and the output of the abnormality detecting portion 15.

The gate electrode driving portion 44'selects one buffer in the three-state buffer 44-2 in synchronization with the gate electrode drive start purse 12C inputted into the, shift register 44-1 and the shift clock for gate electrode selection 12D. Moreover, the gate electrode applied voltage 44A (a scanning voltage) is outputted from the selected buffer to the gate electrode 21. The switch 44-4 is turned on or off according to the input enable signal 15C inputted from the abnormality detecting portion 15, thereby the output of the gate electrode applied voltage 44A is turned on or off.

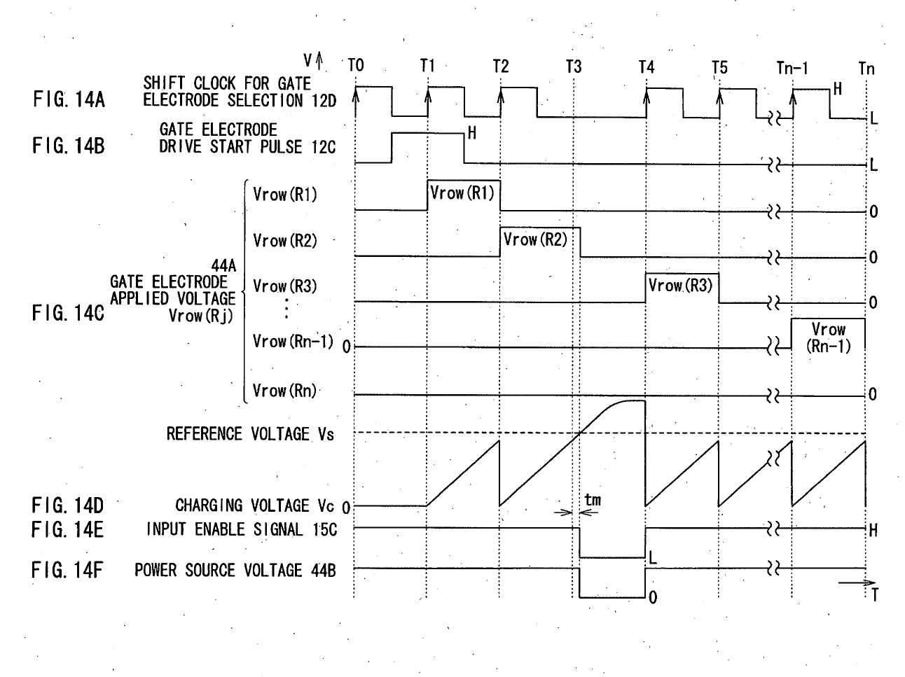

FIGS. 14A through 14F show timing charts for describing the operation of the gate electrode driving portion 44. More specifically, in the case where the same abnormality as that in FIGS. 11A through 11E occurs in the shift clock for gate electrode selection 12D, the state where the gate voltage 3A supplied to the three-state buffer 44-2 is cut off is shown in FIGS. 14A through 14F.

In the case where an abnormality occurs in the shift clock for gate electrode selection 12D, as shown in FIG. 14F, a power source voltage 44B supplied to the three-state buffer 44-2 is cut off, and as shown in FIG. 14C, the output from the three-state buffer 44-2 to the gate electrode 21 is suspended. As a result, as described in the first embodiment, the gate-cathode voltage Vgc can be equal to or lower than the cutoff voltage 40, so the gate-cathode voltage Vgc exceeding the cutoff voltage 40 can be prevented from being applied to pixels for a time largely exceeding the normal time.

Therefore, in the embodiment, there is no possibility that abnormal display that the high brightness line in a horizontal direction is generated on the screen occurs, and there is no possibility that a decline in display characteristics in the cathode device due to deterioration or the like occurs, or pixel damage such as damage to the resistive layer disposed on the bottom surface of the cathode device occurs.

Thus, in the embodiment, in the case where an abnormality occurs in the shift clock for gate electrode selection 12D, the output from the gate electrode driving portion 44 to the gate electrode 21 is suspended, so that the gate-cathode voltage Vgc assumes equal to or lower than the cutoff voltage 40, so abnormal display, a decline in display characteristics, and pixel damage due to an abnormal input of the shift clock for gate electrode selection 12D can be prevented.

In the case where the pulse waveform of the shift clock for gate electrode selection 12D is inputted into the discharging circuit 15-3, the charging voltage Vc falls below the reference voltage Vs, so as shown in FIG. 14E, the comparison circuit 15-4 which detects that the charging voltage Vc falls below the reference voltage Vs outputs the input enable signal 15C again. As a result, the suspension of the output to the three-state buffer 44-2 is removed. Therefore, in the embodiment, as in the case of the first embodiment, in the case where the shift clock for gate electrode selection 12D is recovered to a normal condition, more specifically in the case where the charging voltage Vc assumes equal to or lower than the reference voltage Vs, the gate electrode driving portion 44 can continue scanning the gate electrode.

### Third Embodiment

Next, a third embodiment of the invention will be described below.

The purpose of the first embodiment is to suspend the output from the gate electrode driving portion 14 to the gate electrode 21 in the case where an abnormality occurs in the shift clock for gate electrode selection 12D. On the other hand, the purpose of the embodiment is to suspend the output from the gate electrode driving portion 14 to the gate electrode 21 in the case where an abnormality occurs in the gate electrode driving portion 14.

The embodiment differs from the first embodiment in including an abnormality detecting portion 45 instead of the abnormality detecting portion 15, and changing a connection relationship between the abnormality detecting portion 45, the control signal producing portion 12 and the gate electrode driving portion 14. The same structures, operations and functions as those in the first embodiment will not be further described, and the above-described differences will be described in detail below.

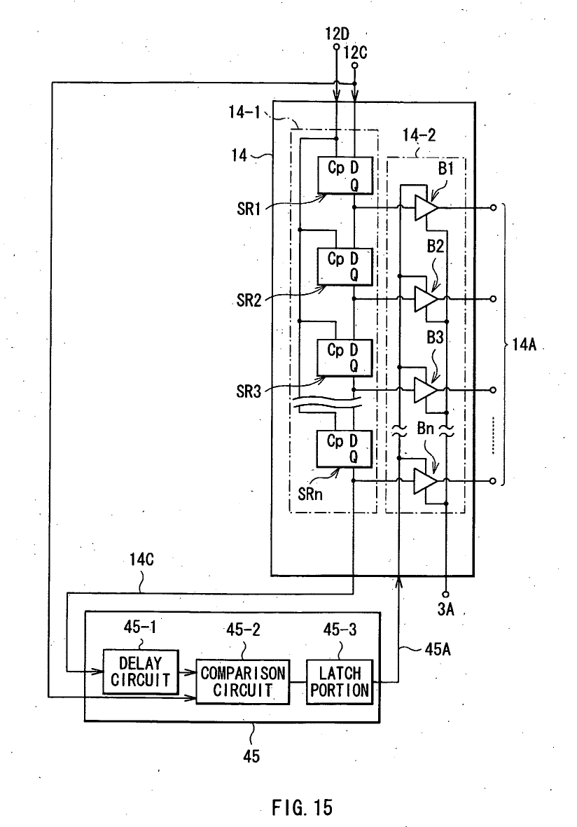

FIG. 15 shows a schematic block diagram of the gate electrode driving portion 14 and the abnormality detecting portion 45 according to the embodiment. The abnormality detecting portion 45 includes a delay circuit 45-1, a comparison circuit 45-2 and a latch portion 45-3.

In the abnormality detecting portion 45, the input of the delay circuit 45-1 is connected to a final stage output 14C of the shift register 14-1. The input of the comparison circuit 45-2 is connected to the outputs of the delay circuit 45-1 and the control signal producing portion 12. The input of the latch portion 45-3 is connected to the output of the comparison circuit 45-2, and the output of the latch portion 45-3 is connected to the input of the three-state buffer 14-2.

The gate electrode driving portion 14 sequentially selects one buffer in the three-state buffer 14-2 in synchronization with the gate electrode drive start pulse 12C inputted into the shift register 14-1 and the shift clock for gate electrode selection 12D. Moreover, the gate electrode applied voltage 14A (a scanning voltage) is inputted from the selected buffer to the gate electrode 21. The power source 14-3 supplies power to the three-state buffer 14-2. Further, the final stage output 14C of the shift register 14-1 is inputted into the delay circuit 45-1.

The abnormality detecting portion 45 suspends the output, of an output enable signal 45A in the case where the output of the gate electrode drive start pulse 12C is “1”, and the output of the final state output 14C of the shift register 14-1 is “0”, that is, in the case where the shift register 14-1 abnormally operates so that it is difficult to turn the output of the gate electrode drive start pulse 12C to “1” with an appropriate period. On the other hand, in the case where the output of the gate electrode drive start pulse 12C is “1” and the output of the final stage output 14C of the shift register 14-1 is “1”, that is, in the case where the shift register 14-1 operates normally so that the output of the gate electrode drive start pulse 12C can be turned to “1” with an appropriate period, the output enable signal 45A is outputted.

However, in the first period after the power is turned on, when the output of the gate electrode drive start pulse 12C is “1”, the output of the final stage output 14C of the shift register 14-1 assumes “0”. Therefore, the latch portion 45-3 appropriately controls the output of the abnormality detecting portion 45 so as to prevent the suspension of the output of the output enable signal 45A in the case of normal conditions including the above-described case.

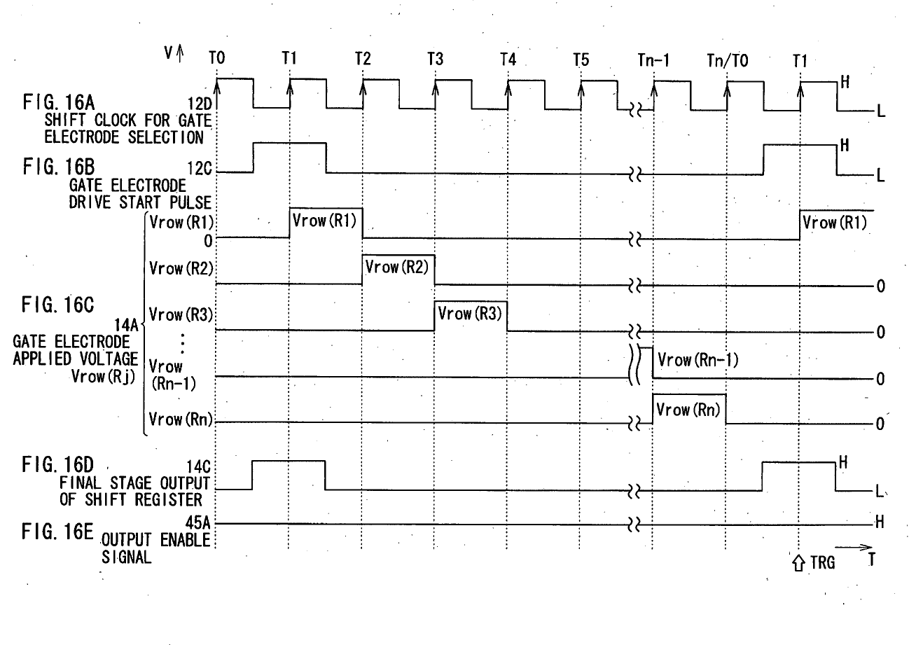

In the latch portion 45-3, the timing to determine whether the shift register 14-1 operates normally or not is an instant (TRG) during the time when the output of the gate electrode drive start pulse 12C is “1” as shown in FIG. 16. In the case where it is once determined that the shift register 14-1 operates normally, the output enable signal 45A is outputted pending the determination whether the shift register 14-1 operates normally or not at the next instant (TRG). On the other hand, in the case where it is once determined that the shift register 14-1 operates abnormally, it is considered that there is little possibility that the shift register 14-1 is recovered, and after that, the output of the output enable signal 45A is continuously suspended.

Next, the operations of the gate electrode driving portion 14 and the abnormality detecting portion 25 will be described in detail below.

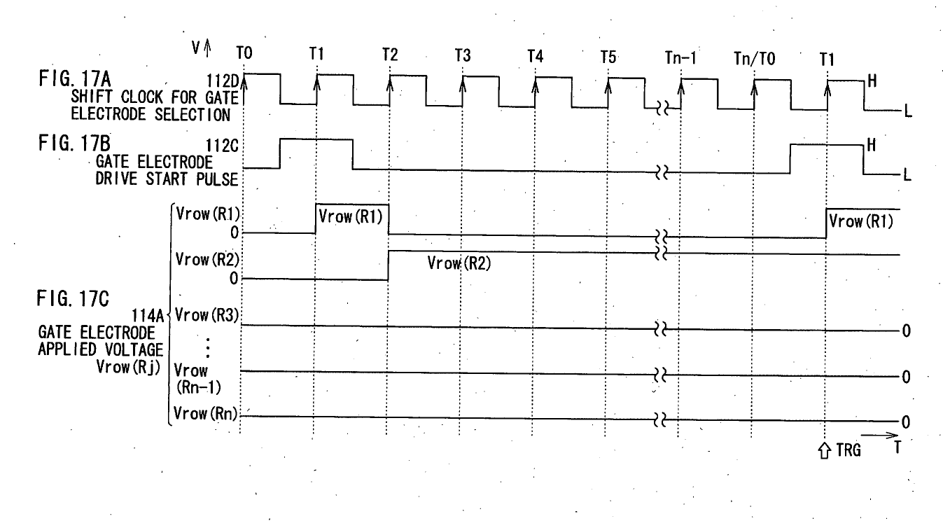

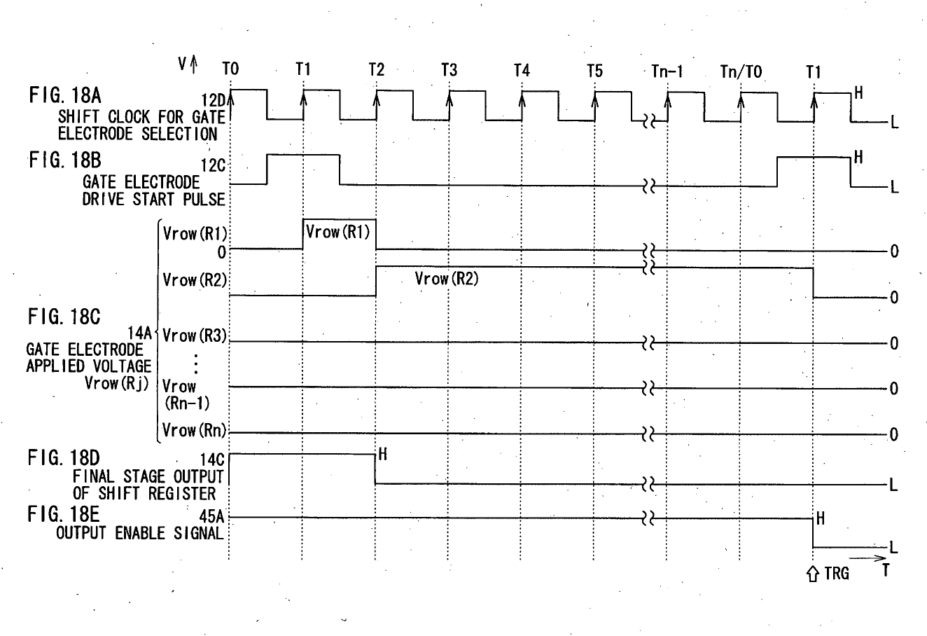

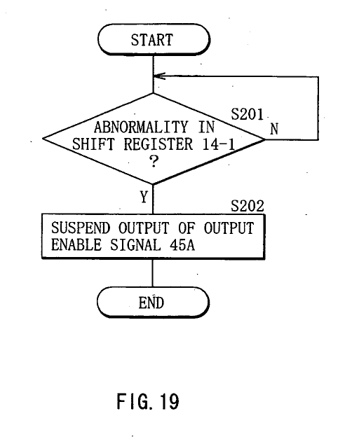

FIGS. 16A through 16E show timing charts for describing the abnormality detecting portion 45 in the case where the shift register 14-1 is in a normal condition in the embodiment. FIGS. 17A through 17C show timing charts for describing the state where an abnormality occurs in the shift register 14-1 in the case where the abnormality detecting portion 45 is not included as a comparative example. More specifically, the case where the second register in the shift register 14-1 is broken and the output is “1” at all time, thereby the voltage Vrow (R2) is continuously applied to the gate electrode 21 in the second row is shown in FIGS. 17A through 17C. FIGS. 18A through 18E show timing charts for describing the operation of the abnormality detecting portion 45 in the case where an abnormality shown in FIGS. 17A through 17C occurs in the shift register 14-1 in the embodiment. FIG. 19 shows the steps of detecting an abnormality by the abnormality detecting portion 45.

The abnormality detecting portion 45 regularly monitors the shift clock for gate electrode selection 12D and the final stage output 14C of the shift register 14-1 while the device driving portion 2 operates. As shown in FIGS. 16B and 16D, the shift clock for gate electrode selection 12D and the final stage output 54C of the shift register 14-1 have a pulse waveform with the same voltage level, so they have the same period in general. Thus, in a normal condition, the pulse waveforms are periodically inputted into the delay circuit 45-1.

The delay circuit 45-1 delays the final stage output 14C of the shift register 14-1 by half the period of the shift clock for gate electrode selection 12D. Next, in the comparison circuit 45-2, the result of the comparison between the level of the output of the gate electrode drive start pulse 12C and the level of the final stage output 14C of the shift register 14-1 is inputted into the latch portion 45-3. In other words, in the case where their voltages are in the same level, it is determined that the shift register 14-1 operates normally, and “1” is inputted into the latch portion 45-3. On the other hand, in the case where their voltages are not in the same level, it is determined that the shift register 14-1 does not operate normally, so “0” is inputted into the latch portion 45-3.

In the latch portion 45-3, in the case where the result of the comparison at the above instant (TRG) is “1”, the output enable signal 45A is continuously inputted into the three-state buffer 14-2 until the next instant (TRG). On the other hand, in the case where the result of the comparison at the above instant (TRG) is “0”, the output of the output enable signal 45A is continuously suspended irrespective of whether there is the next input or not. However, as described above, in the first period after turning the power on, it is determined that the shift register 14-1 does not operate normally, and “0” is inputted into the latch portion 45-3, so in such a case, the output of the output enable signal 45A is not suspended, and the output enable signal 45A is continuously inputted into the three-state buffer 14-2 until the result of the comparison at the next instant (TRG) is inputted. In other words, the abnormality detecting portion 45 enables to output into the three-state buffer 14-2 in the case where the shift register 14-1 is in a normal condition.

Now, as a comparative example, the state in which the abnormality detecting portion is not included in the device driving portion in the case where an abnormality occurs in the shift register will be considered below. For example, as shown in FIG. 17C, the case of an abnormality that the second register in the shift register is broken, and the output is “1” at all time, thereby a gate electrode applied voltage 114A (=Vrow (R2)) is continuously applied to the gate electrode in the second row will be considered. When such an abnormality that the voltage Vrow (R2) is continuously applied to the gate electrode in the second row occurs, a voltage equal to or higher than the cutoff voltage 40 is continuously applied to pixels in the second row for a long time. As a result, in addition to the generation of the high brightness line in a horizontal direction on the screen, a decline in characteristics of the cathode device due to deterioration or the like may occur, or damage to a resistive layer disposed on the bottom surface of the cathode device may occur.

However, in the case where the abnormality detecting portion 45 is included in the device driving portion 2 as in the embodiment, the above problems can be solved. More specifically, as described above, in the case where an abnormality occurs in the shift register 14-1, the comparison circuit 45-2 inputs “0” into the latch portion 45-3, and the latch portion 45-3 suspends the output of the output enable signal 45A immediately as shown in FIG. 18E. Moreover, the latch portion 45-3 keeps suspending the output of the output enable signal 45A until, for example, the power of the device driving portion 2 is turned off in order to prevent the voltage Vrow (R2) from being continuously applied to the gate electrode 21 in the second row again.

Thereby, in the case where an abnormality occurs in the gate electrode driving portion 14, as shown in FIG. 18C, the output from the gate electrode driving portion 14 to the gate electrode 21 can be suspended. As a result, as described in the first embodiment, the gate-cathode voltage Vgc can be reduced to lower than the cutoff voltage 40, so the gate-cathode voltage Vgc exceeding the cutoff voltage 40 can be prevented from being applied to pixels for a time largely exceeding the normal time.

Therefore, in the embodiment, there is no possibility that abnormal display that the high brightness line in a horizontal direction is generated on the screen occurs, and there is no possibility that a decline in display characteristics in the cathode device due to deterioration or the like occurs, or pixel damage such as damage to the resistive layer disposed on the bottom surface of the cathode device occurs.

Thus, in the embodiment, in the case where an abnormality occurs in the gate electrode driving portion 14, the output from the gate electrode driving portion 14 to the gate electrode 21 is suspended, so that the gate-cathode voltage Vgc assumes equal to the cutoff voltage 40, so abnormal display, a decline in display characteristics, and pixel damage due to the abnormal input of the shift clock for gate electrode selection 12D can be prevented.

Although the present invention is described referring to three embodiments and the modifications, the invention is not limited to them, and is variously modified.

For example, in the first embodiment and the third embodiment, in the case where an input abnormality occurs in the shift clock for gate electrode selection 12D or an operation abnormality occurs in the shift register 14-1, the input into the three-state buffer 14-2 is suspended; however, the invention is not limited to this. In the case where an input abnormality occurs in the shift clock for gate electrode selection 12D or an operation abnormality occurs in the shift register 14-1, as long as the gate electrode applied voltage can be suspended, the gate electrode driving portion and the abnormality detecting portion may have any structures.

In the third embodiment, the gate electrode driving portion 14 is included; however, as in the case of the second embodiment, the gate electrode driving portion 44 may be included instead of the gate electrode driving portion 14. It is because even if the gate electrode driving portion 44 is included, the same effects as those in the third embodiment can be obtained.

In the first, the second and the third embodiments and the modifications, either the input abnormality in the shift clock for gate electrode selection 12D or the operation abnormality in the shift register 14-1 or the shift register 44-1 is detected; however, both of the abnormalities may be detected at the same time. More specifically, both of the abnormality detecting portions 15 and 45 may be included.

In the second embodiment and the modification of the third embodiment, in the case where an input abnormality occurs in the shift clock for gate electrode selection 12D or an operation abnormality occurs in the shift register 44-1, the output (the gate voltage 3A) of the power source 3 which supplies power to the three-state buffer 44-2 is suspended, so that the gate-cathode voltage Vgc assumes equal to or lower than the cutoff voltage 40; however, the invention is not limited to this. In the case where the input abnormality occurs in the shift clock for gate electrode selection or the operation abnormality occurs in the shift register, the output of the gate electrode applied voltage may be reduced, so that the gate-cathode voltage assumes equal to or lower than the cutoff voltage. A modification of the second embodiment will be described in detail as a representative example.

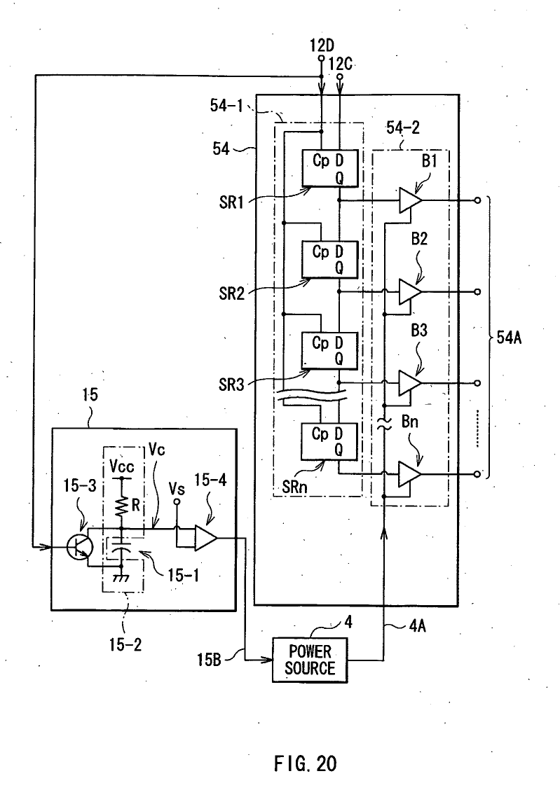

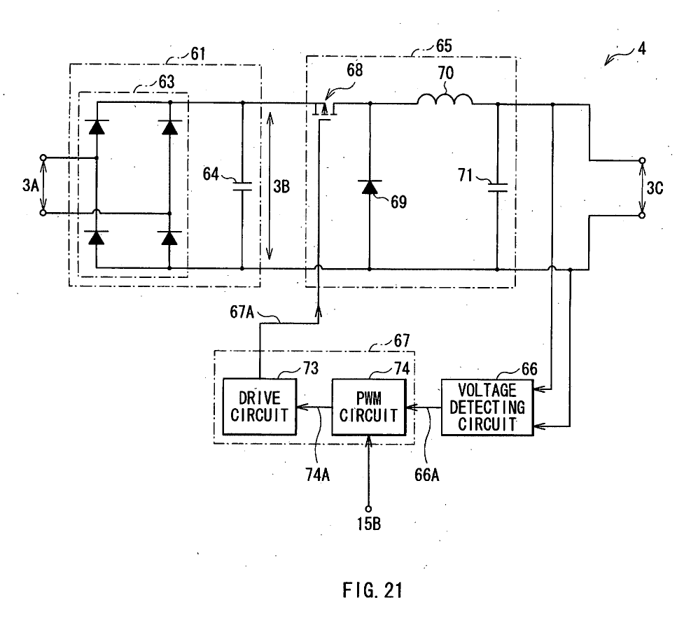

FIG. 20 shows a schematic block diagram of a gate electrode driving portion 54, the abnormality detecting portion 15 and a power source 4 in the modification. FIG. 21 shows a schematic block diagram of the power source 4. The modification differs from the second embodiment in connecting the output of the abnormality detecting portion 15 to the input of a PWM circuit 74 of the power source 4, and directly connecting the output of the power source 4 to the three-state buffer 54-2. The same structures, operations and effects as those in the second embodiment will not be further described, and the above differences will be described in detail below.

In the case where the output enable signal 15B which means enabling to output the output voltage (a gate voltage 4A) of the power source 4 is not inputted into the PWM circuit 74 of the power source 4, a pulse signal 74A is not outputted to the drive circuit 73. In the case where the pulse signal 74A is not inputted into the drive circuit 73, the drive circuit 73 is not able to output the pulse signal 67A to the gate of the MOSFET 68.

In the modification, in the case where an abnormality occurs in the shift clock for gate electrode selection 12D, the output (the gate voltage 4A) of the power source 4 which supplies power to the three-state buffer 54-2 is reduced, so that the gate electrode applied voltage 54A is reduced, for example, from 35 V to 20 V. At this time, the cathode electrode applied voltage 13A is 0 V to 15 V based on an image signal. Therefore, the gate-cathode voltage Vgc with reference to the cathode electrode 20 is 0 V to 20 V, so the voltage Vgc does not exceed the cutoff voltage 40 (for example, 20 V), and electrons 29 are not emitted from the cathode device 25 so that the light emitting layer 27 does not emit light.

As a result, as described in the first embodiment, the gate-cathode voltage Vgc can be-equal to or lower than the cutoff voltage 40, so the gate-cathode voltage Vgc exceeding the cutoff voltage 40 can be prevented from being applied to pixels for a time largely exceeding the normal time.

Therefore, in the modification, there is no possibility that abnormal display that the high brightness line in a horizontal direction is generated on the screen occurs, and there is no possibility that a decline in display characteristics in the cathode device due to deterioration or the like occurs, or pixel damage such as damage to the resistive layer disposed on the bottom surface of the cathode device occurs.

Thus, in the modification, in the case where an abnormality occurs in the shift clock for gate electrode selection 12D, the output from the gate electrode driving portion 54 to the gate electrode 21 is reduced, so that the gate-cathode voltage Vgc assumes equal to or lower than the cutoff voltage 40, so abnormal display; a decline in display characteristics, and pixel damage due to an abnormal input of the shift clock for gate electrode selection 12D can be prevented.

In the modification, the gate-cathode voltage Vgc is controlled to be equal to or lower than the cutoff voltage 40; however, in the case where there is little possibility that a decline in display characteristics or pixel damage occurs, the gate-cathode voltage Vgc may be a little higher than the cutoff voltage 40. For example, the gate-cathode voltage Vgc may be approximately 20 V to 25 V.

Moreover, the invention can be applied to not only the above-described field emission type display but also, for example, image display units such as organic EL displays and LCDs. Further, the invention can be applied to passive matrix displays but also active matrix displays.

Moreover, in the image display unit according to the embodiments of the invention, as described above, the cathode electrode driving portion 13 and the gate electrode driving portions 14, 44 and 54 display an image according to the horizontal synchronous signal 11B and the vertical synchronous signal 11C included in the digital image signal 10A. Therefore, for example, in the case where an abnormality occurs in these signals, or in the case where an abnormality occurs in the shift clock for gate electrode selection 12D generated according to these signals, the above-described problems may occur. Therefore, it can be considered that a synchronous signal different from these signals is separately generated, and an image is displayed according to the synchronous signal, thereby even if an abnormality occurs in the horizontal synchronous signal 11B or the like, the image display unit can prevent the above-described problems due to the abnormality. However, even if the image display unit has such a new structure, in the case where an abnormality occurs in the synchronous signal, the same problems may occur. Therefore, in the abnormality detecting portion 15 or 45 according to the embodiments, even if the above-described different synchronous signal is used, the same problem which may occur in the case where an abnormality occurs in the synchronous signal can be prevented.

It should be understood by those skilled in the art that various modifications, combinations, sub-combinations and alterations may occur depending on design requirements and other factors insofar as they are within the scope of the appended claims or the equivalents thereof.

What is claimed is:

1. An image display unit displaying an image through selecting and driving pixels arranged in a matrix form, the image display unit comprising:
a plurality of first electrodes and a plurality of second electrodes extending in a column direction and a row direction, respectively, so as to intersect and face each other in the position of each pixel;
a first electrode driving means applying a pixel voltage to the first electrodes based on an image signal;
a second electrode driving means sequentially applying a scanning voltage to the second electrodes according to an inputted scan clock, the scanning voltage selecting a pixel row to be driven;
an abnormality detecting means detecting at least either an input abnormality in the scan clock or an operation abnormality in the second electrode driving means; and
a scanning voltage control means controlling the scanning voltage in the case where at least either an input abnormality in the scan clock or an operation abnormality in the second electrode driving means is detected, so that a potential difference between the first electrodes and the second electrodes with reference to the first electrodes assumes equal to or lower than a predetermined value.

2. An image display unit according to claim 1, wherein
the scanning voltage control means turns off the output of the scanning voltage from the second electrode deriving means, so that the potential difference assumes equal to or lower than the predetermined value.

3. An image display unit according to claim 1, wherein
the scanning voltage control means turns off the output of a power source which supplies power to the second electrode driving means, so that the potential difference assumes equal to or lower than the predetermined value.

4. An image display unit according to claim 1, wherein
the scanning voltage control means reduces the output of a power source which supplies power to the second electrode driving means, so that the potential difference assumes equal to or lower than the predetermined value.

5. An image display unit according to claim 1, wherein
the abnormality detecting means includes:
a capacitor;
a charging circuit charging the capacitor;
a discharging circuit discharging the capacitor according to an input of the scan clock; and
a comparison circuit comparing the charging voltage of the capacitor to a reference voltage, and detecting an input abnormality in the scan clock when the charging voltage exceeds the reference voltage.

6. An image display unit according to claim 1, wherein
the second electrode driving means includes a shift register sequentially shifting an inputted vertical synchronous signal according to the scan clock, and
the abnormality detecting means includes a comparison circuit comparing the vertical synchronous signal to a final stage output of the shift register, and detecting an operation abnormality in the second electrode driving means when the result of a comparison shows a mismatch between the vertical synchronous signal and the final stage output of the shift register.

7. A method of driving an image display unit which displays an image through selecting and driving pixels arranged in a matrix form, the method comprising the steps of:
arranging a plurality of first electrodes and a plurality of second electrodes extending in a column direction and a row direction, respectively, so as to intersect and face each other in the position of each pixel;
applying a pixel voltage to the first electrodes based on an image signal;
sequentially applying a scanning voltage to the second electrodes according to an inputted scan clock, the scanning voltage selecting a pixel row to be driven;
detecting at least either an input abnormality in the scan clock or an operation abnormality in the second electrode driving means; and
reducing the scanning voltage in the case where at least either an the input abnormality in the scan clock or an operation abnormality in the second electrode driving means is detected, so that a potential difference between the first electrodes and the second electrodes with reference to the first electrodes assumes equal to or lower than a predetermined value.

8. An image display unit displaying an image through selecting and driving pixels arranged in a matrix form, the image display unit comprising:
a plurality of first electrodes and a plurality of second electrodes extending in a column direction and a row direction, respectively, so as to intersect and face each other in the position of each pixel;
a first electrode driver applying a pixel voltage to the first electrodes based on an image signal;
a second electrode driver sequentially applying a scanning voltage to the second electrodes according to an inputted scan clock, the scanning voltage selecting a pixel row to be driven;
an abnormality detector detecting at least either an input abnormality in the scan clock or an operation abnormality in the second electrode driver; and
a scanning voltage controller controlling the scanning voltage in the case where at least either an input abnormality in the scan clock or an operation abnormality in the second electrode driver is detected, so that a potential difference between the first electrodes and the second electrodes with reference to the first electrodes assumes equal to or lower than a predetermined value.
